(19) United States
(12) Patent Application Publication
(10) Pub. No.: US 2013/0017143 A1
(43) Pub. Date: Jan. 17, 2013

(54) PHOSPHOR AND MANUFACTURING METHOD

(71) Applicants: Michimasa ITO, Aichi (JP); Yuta MATSUSHIMA, Yonezawa-shi (JP); Masahiro HIRO-OKA, Yonezawa-shi (JP)

(72) Inventors: Michimasa ITO, Aichi (JP); Yuta MATSUSHIMA, Yonezawa-shi (JP); Masahiro HIRO-OKA, Yonezawa-shi (JP)

(73) Assignees: YAMAGATA UNIVERSITY, Yamagata (JP); KABUSHIKI KAISHA TOKAI RIKA DENKI SEISAKUSHO, Aichi (JP)

(21) Appl. No.: 13/367,664

(22) Filed: Feb. 7, 2012

(30) Foreign Application Priority Data
Jul. 11, 2011 (JP) 2011-153127
Jul. 11, 2011 (JP) 2011-153128

(51) Int. Cl. C01B 11/00; C01B 11/02

(52) U.S. Cl. 423/463

(57) ABSTRACT

An alkali-earth vanadate compound functioning as a phosphor is a reaction product of vanadium oxide and an alkaline-earth metal or salt thereof.

### CROSS-REFERENCE TO RELATED APPLICATIONS

This application is based upon and claims the benefit of priority from prior Japanese Patent Application Nos. 2011-153127 and 2011-153128, both filed on Jul. 11, 2011, the entire contents of which are incorporated herein by reference.

### BACKGROUND OF THE INVENTION

The present invention relates to a phosphor (or fluorescent substance), for example, a phosphor for a luminous layer of an inorganic electroluminescent (EL) element, fluorescent lamp, light emitting diode (LED), a plasma display, and the like, or a wavelength conversion filter.

An inorganic EL element includes a luminous layer and a dielectric layer which are disposed between a light output-side (or front) transparent electrode and a back electrode. When voltage is applied between the electrodes, the luminous layer produces light. The light passes through the front transparent electrode and emits from the light output side of the EL element, and is used for lighting for example. A conventional luminous layer is formed from a rare earth type phosphor that contains a rare earth added to a host compound (major component) such as zinc sulfide or an alkaline-earth metal phosphate or the like (Japanese Patent Laid-open Publication No. 2010-90346).

### SUMMARY OF THE INVENTION

FIG. 6 shows the emission spectrum of a conventional rare earth type phosphor that contains a rare earth. The emission spectrum of the conventional phosphor exhibits multiple sharp peaks with narrow half-widths in the visible light range. For this reason, there are visible wavelengths that cannot be produced even with a combination of multiple rare earths by a luminous layer consisting of a conventional rare earth type phosphor.

It is an object of the present invention to provide a phosphor for forming a luminous layer that would produce light having a broad emission spectrum peak spanning almost the entire visible light range in the same way as sunlight.

One aspect of the present invention is a phosphor comprising an alkali-earth vanadate compound that is a reaction product of vanadium oxide and an alkaline-earth metal or salt thereof.

In one embodiment, the alkali earth metal or salt thereof is either one of calcium, a calcium salt, strontium, a strontium salt, and a combination thereof. In one embodiment, the alkali-earth metal comprises two or more different alkali-earth metals. In one embodiment, the phosphor includes a compound having a formula of AE₂VO₄X, in which AE is alkali-earth metal and X is halogen. In one embodiment, the phosphor is a non-rare earth type phosphor free from rare earth. In one embodiment, the compound is one of Ca₂VO₄Cl and Sr₂VO₄Cl.

A further aspect of the present invention is a luminous layer comprising the phosphor according to one aspect.

A still further aspect of the present invention is a phosphor manufacturing method. The method includes preparing an alkaline-earth vanadate compound functioning as a phosphor from a mixture of vanadium oxide and an alkaline-earth metal or salt thereof. An amount of the alkaline-earth metal or salt thereof relative to the vanadium oxide in the mixture is in excess relative to a proper amount of an alkaline-earth metal element to a vanadium element as represented by the chemical formula of the alkaline-earth vanadate compound.

In one embodiment, the amount of the alkaline-earth metal or salt thereof relative to the vanadium oxide in the mixture is at least 1.5 times the proper amount. In one embodiment, the preparing includes at least one of concentrating, evaporative-drying, and baking the mixture. In one embodiment, the alkaline-earth vanadate compound is AE₂VO₄X, and AE is an alkaline-earth metal and X is halogen. In one embodiment, the alkaline-earth vanadate compound is one of Ca₂VO₄Cl and Sr₂VO₄Cl. In one embodiment, the vanadium oxide comprises vanadium pentoxide V₂O₅, and the alkaline-earth metal or salt thereof is at least one selected from the group consisting of calcium, a calcium salt, strontium, a strontium salt, or a combination thereof.

An aspect of the present invention is a non-rare earth type phosphor manufacturing method, comprising reacting vanadium oxide and an alkaline-earth metal or salt thereof in an acidic aqueous medium to prepare a non-rare earth type phosphor comprising a compound having a formula of AE₂VO₄X, wherein AE is alkali-earth metal and X is halogen.

In one embodiment, the reacting includes mixing an excess amount of the alkaline-earth metal or salt thereof with the vanadium oxide, concentrating, evaporative-drying, and baking of the mixture

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 shows a schematic view of an inorganic EL element provided with a luminous layer of one embodiment;

FIG. 2 is a table showing alkaline-earth metals, alkaline-earth vanadate compounds, and corresponding emission colors;

FIG. 3 is a chart showing a method for preparing an alkaline-earth vanadate compound;

FIG. 4 is a graph showing the fluorescence intensity of calcium chloride vanadate, with the Ca/V ratio in a mixture of alkaline-earth metal salt and vanadium oxide shown on the horizontal axis;

FIG. 5 shows the emission spectra of Ca₂Vo₄Cl and Sr₂VO₄Cl; and

FIG. 6 shows the emission spectrum of a conventional phosphor for an inorganic EL element.

### DETAILED DESCRIPTION OF EMBODIMENTS

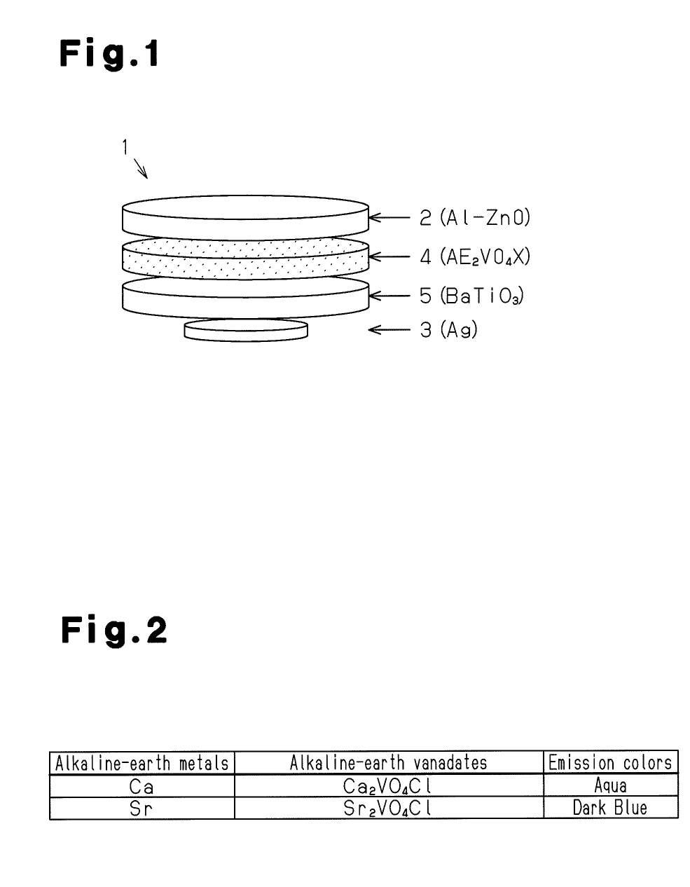

A phosphor of one embodiment of the present invention will now be described below. FIG. 1 shows a thin-film inorganic EL element 1. The inorganic EL element 1 includes a luminous layer (phosphor) 4 and a dielectric layer 5 sandwiched between a transparent electrode 2 and a back electrode 3. The dielectric layer 5 amplifies the alternating drive current and adjusts the light reflection. When voltage is applied between the electrodes 2 and 3, the luminous layer 4 emits light. This light passes through the transparent electrode 2, and is emitted outside the inorganic EL element 1 and may be used for lighting for example. The inorganic EL element 1 emits light with a relatively low voltage of tens of volts for example.

A phosphor (inorganic EL element phosphor) formed from an alkaline-earth vanadate compound is used for luminous layer 4.

The alkaline-earth vanadate compound refers to a compound comprising vanadate and an alkaline-earth metal. The vanadate in this compound may be (VO₄)³⁻ or (V₂O₇)⁴⁻ for example. The alkaline-earth metal in this compound may be calcium (Ca) or strontium (Sr).

As shown in FIG. 2, the emission color of an alkaline-earth vanadate compound differs depending on the type of alkaline-earth metal. For example, the emission color of Ca₂VO₄Cl is aqua, while the emission color of Sr₂VO₄Cl is dark blue.

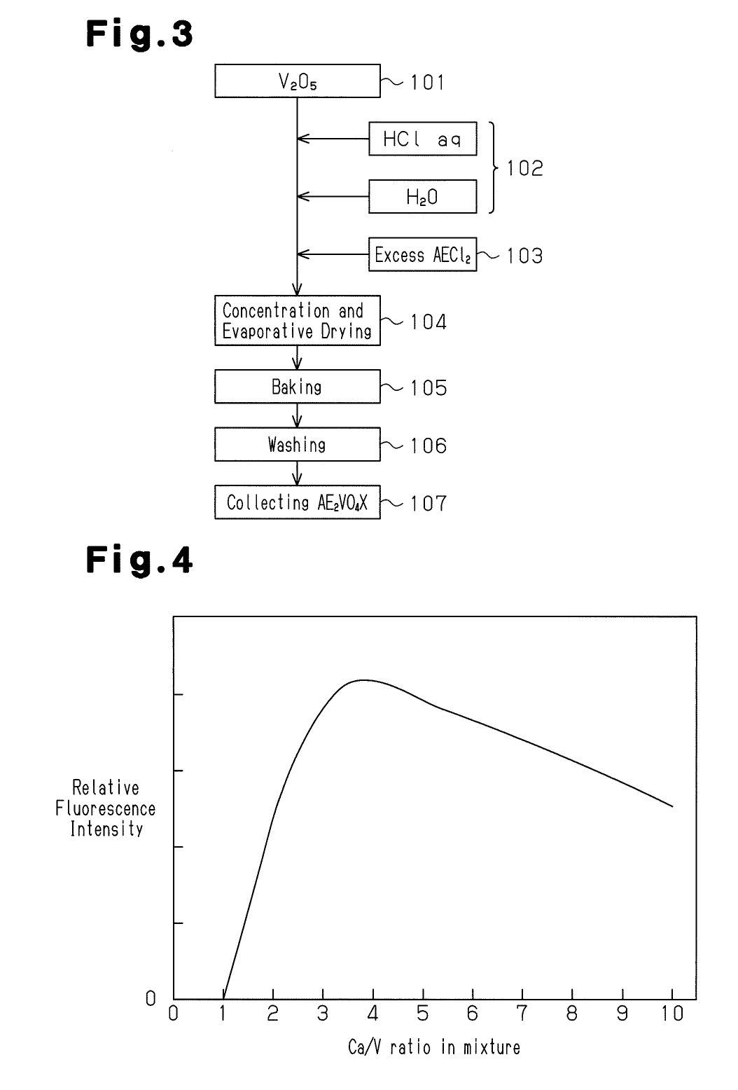

Next, a preparation procedure (synthesis procedure) for an alkaline-earth vanadate compound, AE₂VO₄X, is described using FIG. 3. AE is an alkaline-earth metal, and X is halogen such as Cl.

First, in step 101 (base material preparation step), vanadium oxide such as vanadium pentoxide (V₂O₅) is weighed. The vanadium oxide functions as a base material.

In step 102 (component mixing promoter addition step), a chloride component (HCl) and H₂O are added to the vanadium pentoxide V₂O₅. The added component, i.e., HCl and H₂O, promotes homogeneously mixing without mechanical stress to the reactants when mixing. HCl and H₂O are an example of a component mixing promoter.

In step 103 (alkaline-earth excess addition step), an excess amount of an alkaline-earth chloride, AECl₂, relative to the vanadium pentoxide V₂O₅ is weighed. The excess amount of the alkaline-earth chloride AECl₂ is added to prepare a mixture of the vanadium pentoxide V₂O₅ and the alkaline-earth chloride AECl₂. The added amount of AECl₂ is determined so that the ratio of the alkaline-earth metal to the vanadium in the mixture exceeds the molar ratio 2 of the alkaline-earth metal element to the vanadium element (sometimes called the proper amount in this specification) as given by the chemical formula of the alkaline-earth vanadate compound AE₂VO₄X. Surprisingly, adding an excess amount of the alkaline-earth chloride AECl₂ to the vanadium pentoxide V₂O₅ is effective in preparing a phosphor with high luminance.

The relationship between the amount of the alkaline-earth chloride AECl₂ in the mixture and the luminous intensity of the alkaline-earth vanadate compound AE₂VO₄X will be discussed. FIG. 4 shows the example of the alkaline-earth vanadate compound AE₂VO₄X, in which the alkaline-earth metal AE is Ca and X is Cl. The Ca/V ratio in the reaction mixture of alkaline-earth chloride AECl₂ and vanadium oxide is shown on the horizontal axis. According to stoichiometry, the chemical formula AE₂VO₄X shows a molar ratio (proper amount) of 2 of the alkaline-earth metal AE to the vanadium element V. The luminous intensity of the alkaline-earth vanadate compound is greatly increased if the amount of the alkaline-earth chloride AECl₂ relative to the vanadium oxide in the mixture exceeds the proper amount (Ca/V=2) as shown in FIG. 4. The luminous intensity becomes a maximum when the amount of the alkaline-earth chloride AECl₂ relative to the vanadate in the mixture is twice the proper amount (Ca/V=2) as shown by the chemical formula of the alkaline-earth vanadate compound AE₂VO₄X. When the amount of the alkaline-earth chloride AECl₂ further increases, the luminous intensity decreases gradually. That is, an alkaline-earth vanadate compound with maximum luminance is prepared when the molar ratio of the alkaline-earth metal element AE to the vanadium element V in the mixture is about 4.

One reason why adding an excess amount of the alkaline-earth chloride increases luminance may be that the necessary amount of the alkaline-earth chloride AECl₂ in the composition acts as a self-flux to promote phosphor particle growth for example. It may be that if the alkaline-earth chloride AECl₂ is not present in the necessary amount, there is insufficient flux for phosphor particle growth, so that fewer phosphor particles are produced, while at the same time compounds exhibiting no phosphorescence are produced. Therefore, it is necessary to add an excess amount of the alkaline-earth chloride. Addition of an excess amount of the alkaline-earth chloride may also be necessary in order to compensate for alkaline-earth chloride AECl₂ that is evaporated in the concentration and evaporative drying steps discussed below.

In step 104, the reaction mixture of the vanadium pentoxide V₂O₅ and the alkaline-earth chloride AECl₂ is concentrated and evaporated to dryness (concentration and evaporative drying steps). The concentration step may use an evaporator that evaporates volatile substances (solid and liquid) in the reaction mixture under reduced pressure. The concentration time is 45 minutes for example. In the evaporative drying step, the concentrated mixture is dried for about 2 hours for example with a hot plate heated to about 80° C.

In step 105 (baking step), the dried mixture is baked. When the alkaline earth is calcium, the baking temperature is set at 700° C. to 800° C. When the alkaline earth is strontium, the baking temperature is set at 800° C. to 900° C. The baking time is set at 2 hours for example. The temperature is raised from room temperature to the baking temperature over 1 hour and 20 minutes for example (ramp rate: 10° C./minute), and then cooled to room temperature over about 2 hours (natural cooling without setting a cooling rate).

In step 106 (washing step), the baked product, which is a reaction product of the vanadium pentoxide V₂O₅ and the alkaline-earth chloride AECl₂, is washed. Water or ethanol for example can be used for washing.

In step 107, the phosphor, which is the alkaline-earth vanadate compound AE₂VO₄X, is obtained and collected.

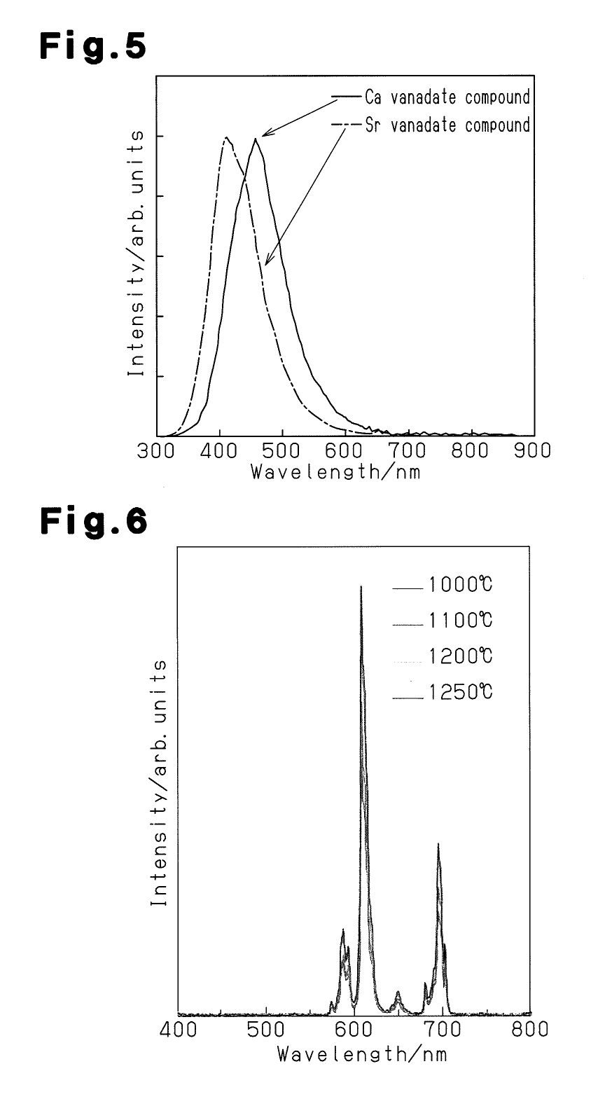

FIG. 5 shows the waveforms of the emission spectra of Ca₂VO₄Cl and Sr₂VO₄Cl, which are examples of the alkaline-earth vanadate compound AE₂VO₄X. Regardless of whether the alkaline earth is calcium or strontium, AE₂VO₄X exhibited an emission spectrum peak with a broad half-width. This shows that AE₂VO₄X itself is a phosphor that emits light having a spectrum peak with a broad half-width like sunlight. This means that a luminous layer using this phosphor can emit light similar to sunlight, and have improved wavelength selectivity when combined with optical filtering.

In a method of manufacturing the alkaline-earth vanadate compound of this embodiment, the amount of the alkaline earth or salt thereof is determined so that the ratio of the alkaline earth or salt thereof to the vanadium oxide in the reaction mixture exceeds the stoichiometric ratio (Ca/V=2) of the alkaline-earth metal element to the vanadium element as given by the chemical formula of the alkaline-earth vanadate compound AE₂VO₄X. As a result, as shown in FIG. 4, the luminance can be increased over that commonly obtained when the ratio of the alkaline earth or salt thereof to the vanadium oxide in the reaction mixture is the proper amount (Ca/V=2) of alkaline-earth metal to vanadium as shown by the chemical formula of the alkaline-earth vanadate compound AE₂VO₄X. Thus, the alkaline-earth vanadate compound of the embodiment is a desirable phosphor having an emission spectrum with a broad half-width and a strong luminance.

The present embodiment has the advantages described below.

(1) An alkaline-earth vanadate compound prepared from a reaction mixture of vanadium oxide and an alkaline-earth metal or salt thereof has the emission characteristics of an emission spectrum with a broad half-width as shown in FIG. 5. An inorganic EL element 1 provided with this alkaline-earth vanadate compound as luminous layer 4 can produce light having a spectrum peak with a broad half-width similar to sunlight. Wavelength selectivity is also improved in combination with optical filtering.

(2) A reaction product of vanadium oxide and an alkaline-earth metal (Ca, Sr), or an alkaline-earth vanadate compound, has been shown to be a phosphor that emits light having an emission spectrum peak with a broad half-width. Thus, a phosphor having an emission spectrum peak with a broad half-width can be prepared from commonly-used vanadium oxide and alkaline-earth metals, without the use of rare earths.

(3) A phosphor of an embodiment prepared by adding an excess amount of an alkaline-earth metal to a vanadium oxide base material (vanadium pentoxide V₂O₅) can produce light with strong luminance as shown in FIG. 4.

(4) Since vanadium oxide is an oxide that resists oxidation, it is easier to manufacture the phosphor of the embodiment than it would be using a material that oxidizes easily. Therefore, in use of the phosphor of the embodiment it is possible to provide an inorganic EL element or other luminous element or wavelength conversion filter that resists oxidation, contributing to a longer product life.

(5) The amount of the alkaline-earth metal or salt thereof in the mixture is set to at least 1.5 times the proper amount (Ca/V=2) of the alkaline-earth metal element relative to the vanadium element as represented by the chemical formula of the alkaline-earth vanadate compound AE₂VO₄X. In this way, a phosphor can be produced having greater luminance than that obtained when the amount of the alkali-earth metal or salt thereof in the reaction mixture is the proper amount (Ca/V=2) of the alkaline-earth metal relative to the vanadium as represented by the chemical formula of the alkaline-earth vanadium compound AE₂VO₄X. See FIG. 4.

(6) Because the reaction mixture of vanadium oxide with an excess amount of an alkaline-earth metal is subjected to further treatment (concentration, evaporative drying, baking, washing) to prepare an alkaline-earth vanadate compound as a phosphor, the prepared phosphor is thermally and chemically stable.

It should be apparent to those skilled in the art that the present invention may be embodied in many other specific forms without departing from the spirit or scope of the invention. Particularly, it should be understood that the present invention may be embodied in the following forms.

The excess added amount of the alkaline earth is preferably at least 1.5 times as shown by the experimental results of FIG. 4, but this is not a limitation. That is, the added amount of the alkaline-earth metal or salt thereof can be altered as necessary as long as the amount of the alkaline-earth metal AE in the mixture is an excess relative to the proper amount.

There is no particular upper limit on the added amount of the alkaline-earth metal or salt thereof, but an upper limit may be set. For example, the upper limit of the amount of the alkaline-earth metal or salt thereof in the mixture may be set at 3 times (Ca/V=6 in FIG. 4) or 4 times (Ca/V=8 in FIG. 4) the proper amount.

In step 101, vanadium oxide other than vanadium pentoxide V₂O₅ may be used.

Another metal having similar properties to the alkaline-earth metals Ca and Sr, such as Group II element of barium (Ba) or magnesium (Mg), can be used instead.

The alkaline-earth vanadate compound can be manufactured by another manufacturing method, not limited to the manufacturing method discussed in the embodiment.

The excess added amount (ratio) of the alkaline-earth chloride to the vanadium pentoxide V₂O₅ can be altered as necessary.

The conditions of the concentration, evaporative drying, baking and washing steps can be altered as necessary.

The composition mixing promoters supplied in step 102 are not limited to chloride components and water, and other materials can be used.

Multiple kinds of alkaline-earth metals or salts thereof may be added in step 103. In this case, AE₂VO₄X is provided with multiple kinds of alkaline-earth metals AE. The emission color can be adjusted by altering the kinds and proportions of alkaline earths that are combined.

The phosphor can be used not only in an inorganic EL element, but also in a fluorescent lamp, LED, plasma display and wavelength conversion filter.

X is not limited to Cl, and may be other halogen such as Br, F and any combination thereof.

The present examples and embodiments are to be considered as illustrative and not restrictive, and the invention is not to be limited to the details given herein, but may be modified within the scope and equivalence of the appended claims.

What is claimed is:

1. A phosphor comprising an alkali-earth vanadate compound that is a reaction product of vanadium oxide and an alkaline-earth metal or salt thereof.

2. The phosphor according to claim 1, wherein the alkali earth metal or salt thereof is either one of calcium, a calcium salt, strontium, a strontium salt, and a combination thereof.

3. The phosphor according to claim 1, wherein the alkali-earth metal comprises two or more different alkali-earth metals.

4. A luminous layer comprising the phosphor according to claim 1.

5. A phosphor comprising a compound having a formula of AE₂VO₄X, wherein AE is alkali-earth metal and X is halogen.

6. The phosphor according to claim 5, wherein the phosphor is a non-rare earth type phosphor free from rare earth.

7. The phosphor according to claim 5, wherein the compound is one of Ca₂VO₄Cl and Sr₂VO₄Cl.

8. A luminous layer comprising the phosphor according to claim 5.

9. A phosphor manufacturing method, comprising:
preparing an alkaline-earth vanadate compound functioning as a phosphor from a reaction mixture containing vanadium oxide and an alkaline-earth metal or salt thereof,
wherein an amount of the alkaline-earth metal or salt thereof relative to the vanadium oxide in the reaction mixture is in excess relative to a proper amount of an alkaline-earth metal element to a vanadium element as represented by the chemical formula of the alkaline-earth vanadate compound.

10. The method according to claim 9, wherein the amount of the alkaline-earth metal or salt thereof relative to the vanadium oxide in the reaction mixture is at least 1.5 times the proper amount.

11. The method according to claim 9, wherein the preparing includes at least one of concentrating, evaporative-drying, and baking the reaction mixture.

12. The method according to claim 9, wherein the alkaline-earth vanadate compound is AE₂VO₄X, and AE is an alkaline-earth metal and X is halogen.

13. The method according to claim 9, wherein the alkaline-earth vanadate compound is one of Ca₂VO₄Cl and Sr₂VO₄Cl.

14. The method according to claim 9, wherein the vanadium oxide comprises vanadium pentoxide V₂O₅, and the alkaline-earth metal or salt thereof is at least one selected from the group consisting of calcium, a calcium salt, strontium, a strontium salt, or a combination thereof.

15. A non-rare earth type phosphor manufacturing method, comprising:
reacting vanadium oxide and an alkaline-earth metal or salt thereof in an acidic aqueous medium to prepare a non-rare earth type phosphor comprising a compound having a formula of AE₂VO₄X, wherein AE is alkali-earth metal and X is halogen.

16. The method according to claim 15, wherein the reacting includes mixing an excess amount of the alkaline-earth metal or salt thereof with the vanadium oxide, concentrating, evaporative-drying, and baking the mixture.
